(19) United States
(12) Patent Application Publication
(10) Pub. No.: US 2017/0300553 A1
(43) Pub. Date: Oct. 19, 2017

(54) SYSTEM AND METHODOLOGY FOR PROPAGATING MODIFICATIONS IN KEY-VALUE PAIRS ACROSS A CLUSTER OF COMPUTERS

(71) Applicant: Knight Point Systems, Inc., Reston, VA (US)

(72) Inventors: Roy Keene, Reston, VA (US); Kenneth Van Alstyne, Reston, VA (US)

(73) Assignee: Knight Point Systems, Inc., Reston, VA (US)

(21) Appl. No.: 15/461,766

(22) Filed: Mar. 17, 2017

Related U.S. Application Data
(60) Provisional application No. 62/312,531, filed on Mar. 24, 2016.

(51) Int. Cl. G06F 17/30; G06F 3/06; H04L 9/32

(52) U.S. Cl. CPC G06F 17/30581; H04L 9/3297; G06F 17/30377; G06F 3/0619; G06F 3/065; G06F 3/067

(57) ABSTRACT

A system and method for propagating modifications in key-value pairs across a cluster of computer system devices. The system comprises a cluster of computer system devices, each comprising a memory device and a processor. The memory device stores a set of key-value pairs, associated with a timestamp. The system comprises an input module, configured to receive a first instruction to modify, a first set of key-value pairs, generate a first timestamp for the first set of key-value pairs, and receive a second timestamp associated with a second set of key-value pairs. Further, the system comprises a comparator module, configured to compare the first timestamp with the second timestamp. Moreover, the system comprises a propagation module, to replace key-value pairs in the second set of key-value pairs with key-value pairs in the first set of key-value pairs.

### CROSS REFERENCE TO APPLICATION

This patent application claims the benefit of U.S. Provisional Application No. 62/312,531 filed on Mar. 24, 2016. The above application is incorporated by reference herein in its entirety.

### FIELD OF THE INVENTION

The present invention relates generally to a system and method for propagating keys and values across cluster nodes to communicate system configuration and implement automated system changes, and more particularly, to a system and method for communicating and implementing system/network configuration information and changes by means of a peer-to-peer network synchronization concept.

### BACKGROUND OF THE INVENTION

Cluster of computer systems refer to a group of computing devices interconnected via a communications network. As such, cluster computer systems act effectively as a single system with each computer system of the cluster of computer systems assigned tasks, which are scheduled by a software. Cluster computer systems are autonomous systems, but they need to all act together to achieve a common unified goal. Typically, specific goals and configuration items are stored in one of the computer systems and the autonomous computer systems reconfigure themselves accordingly. Similarly, configuration tools for implemented automated system changes exist. These tools, however, require centralized management—something that does not work in a clustered computer system configuration where no centralized or “master” computer system exists. For a solution of this nature, management must be decentralized, where configuration changes made on any one computer system in the cluster propagates to every other computer system eventually. Furthermore, keys must be made available in a human readable format and the cluster configuration software must be able to deal with “informational” keys as well as “configuration” (i.e. the cluster name and/or login banner).

Hence, there is a need for a system and method, for automated propagation of data across a cluster of computer systems. Furthermore, there is a need for a system and method, for automated propagation and implementation of configuration changes across a cluster of computer systems.

### SUMMARY OF THE INVENTION

The present invention relates to a system and method for propagating modifications in key-value pairs across a cluster of computer system devices.

In one embodiment of a present invention, a system for propagating modifications in key-value pairs across a cluster of computer system devices comprises a cluster of computer system devices, one or more memory device, and a plurality of processors. The one or more memory devices are comprised in one or more computer system devices of the cluster of computer system devices. Each memory device among the one or more memory devices stores a set of program modules, and a set of key-value pairs. The set of key-value pairs is associated with a timestamp. Each processor among the plurality of processors, is comprised in the cluster of computer system devices. At least one processor executes the set of program modules. The set of program modules comprises an input module, a comparator module, and a propagation module. The input module, executed by the at least one processor, is configured to receive a first instruction to modify, a first set of key-value pairs, the first set of key-value pairs being stored in a first memory device among the one or more memory devices. Further, the input module is configured to modify the first set of key-value pairs based on the first instruction. Furthermore, the input module is configured to generate a first timestamp for the first set of key-value pairs. Further, the input module is configured to receive a second timestamp associated with a second set of key-value pairs. The second set of key-value pairs being stored in a second memory device among the one or more memory devices. The first timestamp references to time of modification of the first set of key-value pairs. The comparator module, executed by the processor, is configured to compare the first timestamp with the second timestamp. The propagation module, executed by the processor, configured to replace key-value pairs in the second set of key-value pairs with key-value pairs in the first set of key-value pairs, based on time referenced by the first timestamp being later than time referenced by the second timestamp.

In one embodiment of the present invention, the first instruction instructs the at least one processor to at least one of modify a first value set in the first set of key-value pairs, insert a first key-value pair into the first set of key-value pairs, delete at least one key-value pair from the first set of key-value pairs, and modify at least one key from the first set of key-value pairs. The input module receives the first instruction from at least one of a user and at least one computer system device in the cluster. Values in the set of key-value pairs are at least one of license keys, authorization keys, encryption keys, authentication information, network information, hot patch scripts, boot file scripts, user information, multimedia files, documents, system files, and image files. It is to be understood, of course, that the values in the set of key-value pairs is not to be limited to those disclosed herein, as such may be anything, including even arbitrary notes to propagate throughout the cluster. The comparator module is further configured to compare each key-value pair in the first set of key-value pairs with each key-value pair in the second set of key-value pairs, based on time referenced by the first timestamp being later than time referenced by the second timestamp. Each computer system device in the cluster of computer system device is at least one of a laptop, a server, a network hardware device, a personal computer, and a smart phone, or any combination thereof. The timestamp references time of modification of the set of key-value pairs. The network hardware device is at least one of a gateway, a router, a network bridge, a modem, a wireless access point, and a network switch. It is to be understood, of course, that the network hardware device is not to be limited to those disclosed herein, as such is a connection between cluster nodes and may be as simple as a cable between the cluster nodes.

In one embodiment of the present invention, a method of propagating modifications in key-value pairs across a cluster of computer system devices comprises storing in each memory device of one or more memory devices, a set of key-value pairs, wherein the set of key-value pairs is associated with a timestamp. Further, the method comprises receiving at least one processor via an input module, a first instruction to modify, a first set of key-value pairs, the first set of key-value pairs being stored in a first memory device among the one or more memory devices. Further, the method comprises modifying by the at least one processor via the input module, the first set of key-value pairs based on the first instruction. Further, the method comprises generating by the at least one processor via the input module, a first timestamp for the first set of key-value pairs, wherein the first timestamp references time of modification of the first set of key-value pairs. Further, the method comprises receiving by the at least one processor via the input module, second timestamp associated with a second set of key-value pairs, the second set of key-value pairs being stored in a second memory device among the one or more memory devices. Further, the method comprises comparing by the at least one processor via the comparator module, the first timestamp with the second timestamp. Further, the method comprises replacing by the at least one processor via a propagation module, key-value pairs in the second set of key-value pairs with key-value pairs in the first set of key-value pairs, based on time referenced by the first timestamp being later than time referenced by the second timestamp, thereby synchronizing the first memory device with the second memory device.

### BRIEF DESCRIPTION OF DRAWINGS

FIG. 1 is a block diagram of an environment implemented in accordance with various embodiments of the invention.

FIG. 2 is a block diagram of a system for propagating modifications in key-value pairs across a cluster of computer systems in accordance with various embodiments of the invention.

FIG. 3 exemplarily illustrates a schematic diagram showing a cluster control state transition from state zero (root state) through to state forty, according to an embodiment of the present invention.

FIG. 4 exemplarily illustrates a schematic diagram showing a cluster control peer-to-peer connection as between computer systems of the cluster of computer systems, according to an embodiment of the present invention.

FIG. 5 is a flowchart of a computer implemented method of propagating modifications in key-value pairs across a cluster of computer systems in accordance with various embodiments of the invention.

### DETAILED DESCRIPTION

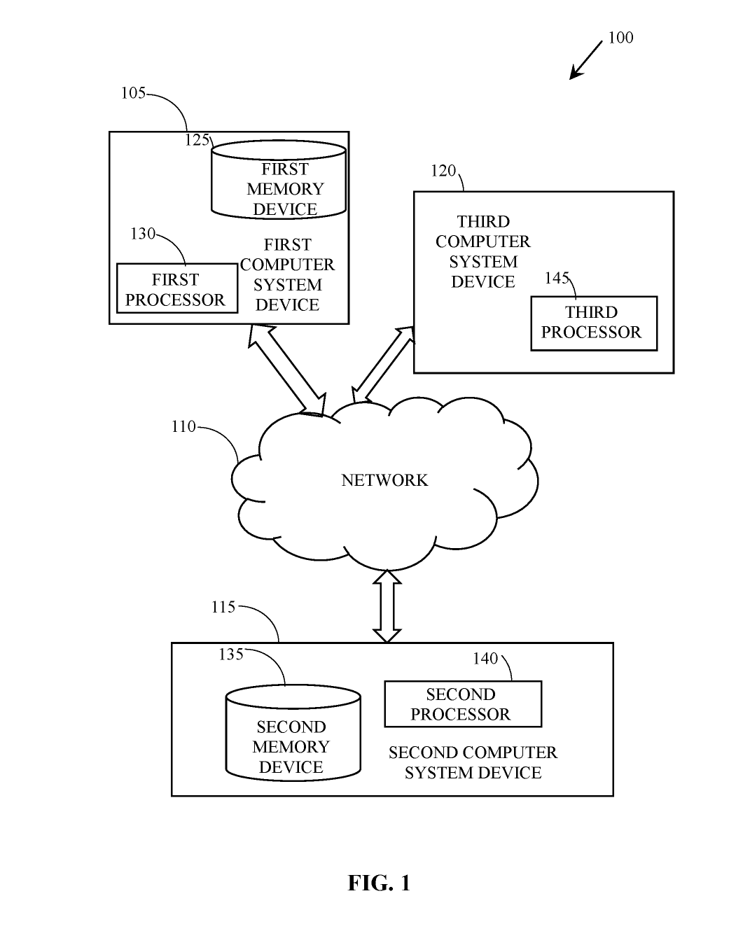

FIGS. 1 through 5 illustrate a system and method by which communication and implementation of system/network keys and values, corresponding to system/network configuration and changes thereto, is accomplished. Such communication and implementation utilizes a peer-to-peer connection design to propagate the system/network configuration and changes through the system/network. Each node of a particular cluster communicates, and/or seeks to establish communication, with three other nodes of the same cluster. A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

Referring now to FIG. 1, such is a block diagram of an environment 100 in accordance with which various embodiments of the present invention are implemented. The environment 100 comprises a first computer system device 105, a second computer system device 115 and a third computer system device 120. In one example, the first computer system device 105, the second computer system device 115, and the third computer system device 120 are connected as a computer cluster. The first computer system device 105, the second computer system device 115, and the third computer system device 120 are at least one of a laptop, a personal computer, a server, a smart phone, a network hardware device, and a smart television. The network hardware device is at least one of a gateway, a router, a network bridge, a modem, a wireless access point, and a network switch. In another example, the first computer system device 105, the second computer system device 115, and the third computer system device 120 are gateways to at least one of a wide area network, a local area network, and internet. The first computer system device 105, the second computer system device 115, and the third computer system device 120 are connected via a network 110. The network 110 is at least one of a mobile network, a wide area network, a local area network, and internet. The first computer system device 105 comprises a first memory device 125 and a first processor 130. The second computer system device 115 comprises a second memory device 135, and the second processor 140. The third computer system device 120 comprises the third processor 145. In one embodiment of the present invention, the computer cluster comprising the first computer system device 105, the second computer system device 115, and the third computer system device 120 hosts a system for patching software in a target computer system device. In one example, the target computer system device is at least one of the first computer system device 105, the second computer system device 115, and the third computer system device 120.

At least one of the first memory device 125 and the second memory device 135 stores a set of program modules. Further, each of the first memory device 125 and the second memory device 135 stores a set of key-value pairs. The set of key-value pairs is associated with a timestamp. The timestamp references to time of modification of the set of key-value pairs. In one example, the first memory device 125 stores a first set of key-value pairs, and the second memory device 135 stores a second set of key-value pairs.

The set of program modules comprises an input module (not shown), a comparator module (not shown), and a propagation module (not shown). At least one processor among the first processor 130, the second processor 140, and the third processor 145 executes the set of program modules. The at least one processor executes the set of program modules to propagate modifications in key-value pairs across the cluster. In one example, the set of program modules are executed by a combination of multiple processors among the first processor 130, the second processor 140, and the third processor 145.

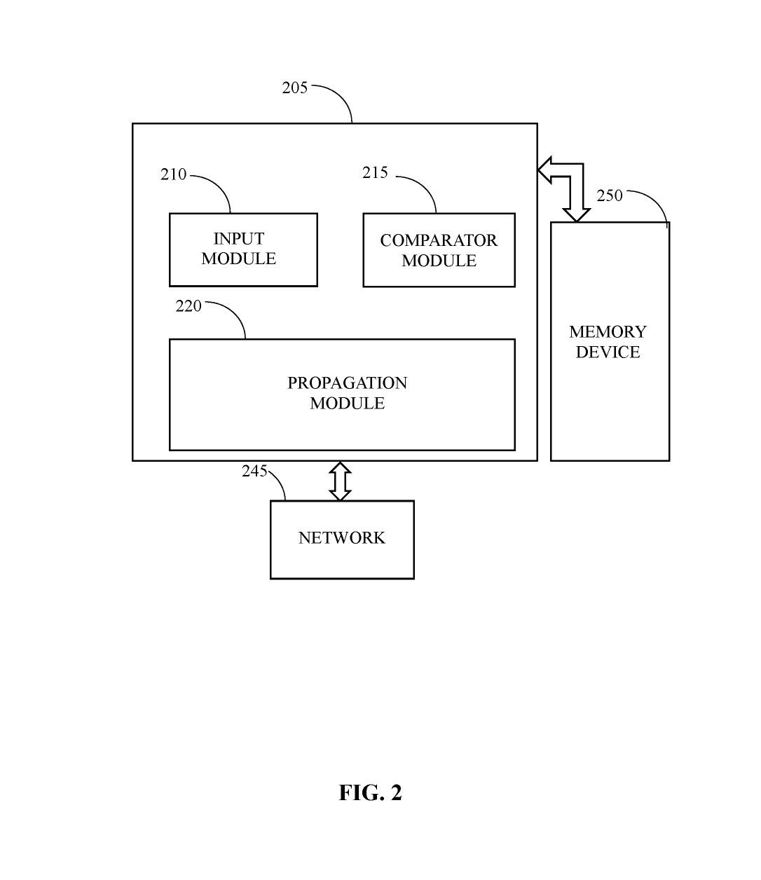

FIG.2 is a block diagram of a system for propagating modifications in key-value pairs across a cluster of computer system devices according to one example of functioning of the present invention.

Referring now to FIG. 2, in one example, a memory device 250 stores a set of program modules. Further, the memory device 250 stores a set of key-value pairs. The set of key-value pairs is associated with a timestamp. The set of key-value pairs store at least one of license keys, authorization keys, encryption keys, authentication information, system configuration information, system configuration settings, network information, hot patch scripts, boot file scripts, user information, multimedia files, documents, system files, and image files. It is to be understood, of course, that the values in the set of key-value pairs is not to be limited to those disclosed herein, as such may be anything, including even arbitrary notes to propagate throughout the cluster. The memory device 250 enables retrieval of the set of program modules and the set of key-value pairs into a processor 205. In one example, the processor 205 executes the set of program modules. The memory device 250 and the processor 205 are connected to a cluster of computer system devices via a network 245.

In one example, a system for propagating modifications in key-value pairs across a cluster of computer system devices comprises a plurality of processors (not shown). Each processor among the plurality of processors, is comprised in the cluster of computer system devices. At least one processor executes the set of program modules. In one example, the processor 205 is one among the plurality of processors and executes the set of program modules. The set of program modules comprises an input module 210, a comparator module 215, and a propagation module 220.

The input module 210, executed by the processor 205, is configured to receive a first instruction to modify a first set of key-value pairs stored in a first memory device (not shown) in the cluster. In one example, the input module 210 receives the first instruction from one of a user and a computer system device. In another example, the first set of key-value pairs is stored in the memory device 250. The first instruction instructs the processor 205 to at least one of modify a first value set in the first set of key-value pairs, insert a first key-value pair into the first set of key-value pairs, delete at least one key-value pair from the first set of key-value pairs, and modify at least one key from the first set of key-value pairs.

Further, the input module 210 modifies the first set of key-value pairs based on the first instruction. Moreover, the input module 210 generates a timestamp referring to time of modification of the first set of key-value pairs. The input module 210 is configured to receive a second timestamp associated with a second set of key-value pairs. The second set of key-value pairs are stored in a second memory device (not shown). The second timestamp represents time of latest modification of the second set of key-value pairs. Further, the input module 210 transmits the second timestamp and the first timestamp into the comparator module 215. The comparator module 215, compares the first timestamp with the second timestamp.

In one example, if time referenced by the first timestamp is later than time referenced by the second timestamp, then the comparator module 215 compares each key-value pair in the first set of key-value pairs with each key-value pair in the second set of key-value pairs.

In one example, the propagation module 220 replaces a first key-value pair in the second set of key-value pairs with a second key-value pair in the first set of key-value pairs, based on the second key-value pair being non-identical with the first key-value pair. In another example, if time referenced by the first timestamp is later than time referenced by the second timestamp, then the propagation module 220, replaces key-value pairs in the second set of key-value pairs with key-value pairs in the first set of key-value pairs.

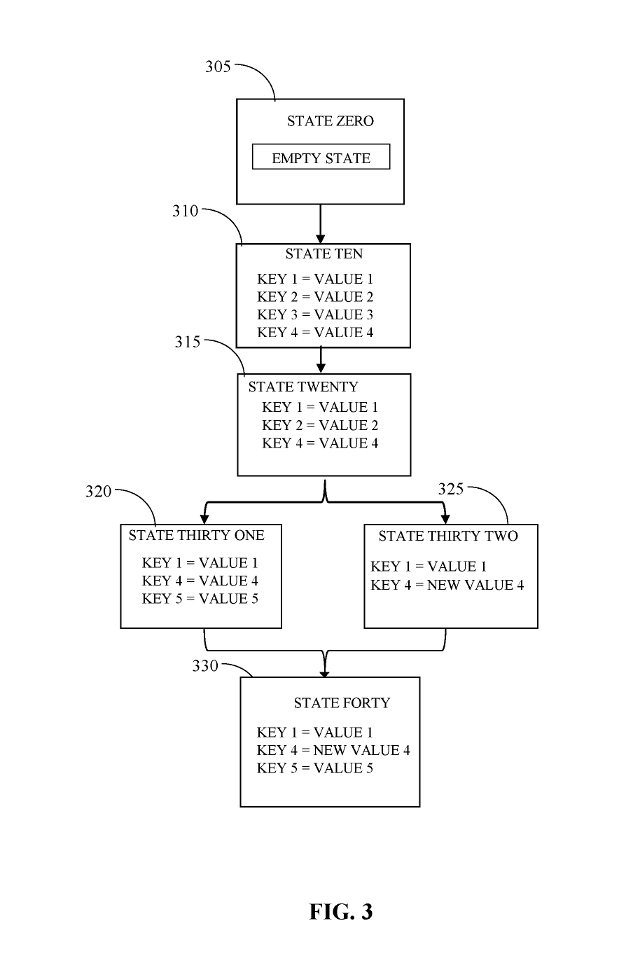

Referring now specifically to FIG. 3, such exemplarily illustrates a state diagram of a cluster of computer system devices during a cluster control state transition from a state zero 305 (root state) through to a state forty 330, according to an embodiment of the present invention. As used herein “a root state” is defined as the initial state of a computer system device of the cluster of computer system devices in which none of the computer system devices store any key-value pairs. In one example, “a key” is a reference to a file stored in a memory device of a computer system device in the cluster. Further, “value” refers to contents of the file. Each data set comprises a plurality of keys or values.

It is noted that the values comprise license files, login keys, authentication information, encryption information, network statistics, and timestamp identifiers. In state 0, the root state, there are no key-value pairs stored in any of the computer system devices in the cluster.

In an example, the computer system device receives a first instruction to add a set of key-value pairs into the memory device. The set of key-value pairs comprises a “key 1” referencing a “value 1”, “key 2” referencing a “value 2”, “key 3” referencing a “value 3”, and “key 4” referencing a “value 4”. The computer system device adds the set of key-value pairs into the memory device and thereby transitions the cluster control state from the state zero 305 to the state ten 310.

In the state ten 310, that is, the set of key-value pairs are present in the computer system device. In state ten 310, the computer system device of the cluster has been populated with multiple keys, for example, key 1, key 2, key 3, key 4. With values 1, 2, 3, 4 are assigned to keys 1, 2, 3, 4 respectively.

In another example, the computer system receives a second instruction to delete “key 3” from the memory device. The computer system device deletes the “key 3” and “value 3” referenced by the “key 3”, from the memory device and the cluster control, state transitions into a state twenty 315. In state twenty 315, that is, the child of state ten 310, the memory device comprises key 1″ referencing a “value 1”, “key 2” referencing a “value 2”, and “key 4” referencing a “value 4”.

It is noted that the set of key-value pairs stored in each memory device of the cluster are identical during the cluster control state. However, the set of key-value pairs in different memory devices is liable to be different during transition.

In another example, a first computer system device in the cluster stores the set of key-value pairs in a first memory device, and a second computer system device in the cluster stores the set of key-value pairs in the second memory device. In one example, the first computer system device receives a second instruction to add a “key 5” associated with the a “value 5” into the first memory device and to delete “key 2”. Similarly, the second computer system device receives a third instruction to delete “key 2” and to assign “new value 4” to “key 4”. The first computer system device modifies the set of key-value pairs into a first set of key-value pairs comprising “key 1” referencing a “value 1”, “key 4” referencing a “value 4” and “key 5” referencing “value 5”. Thus, the first computer system transitions into a state thirty-one 320. In a state thirty-one 320, that is, the child of state twenty 315, three keys and their corresponding values are present in the computer system. Similarly, the second computer system device transitions into state thirty-two 325. In state 32, the second memory device comprises “key 1” referencing a “value 1”, and “key 4” referencing a “new value 4”.

However, the first computer system device and the second computer system device are in states different from the cluster control state. A system for propagating modifications in key-value pairs ensures synchronization of the computer system devices in the cluster. In an exemplary illustration of the working of the present invention, the set of key-value pairs have a timestamp referencing time when the set of key-value pair was last subject to modification. The first computer system device assigns the first set of key-value pairs with a first timestamp, wherein the first timestamp references to time when the first computer system device modified the set of key-value pairs stored in the first memory device into the first set of key-value pairs. The first computer device receives the timestamp from at least one computer system device in the cluster and replaces the set of key-value pairs in the at least one computer system device if the first timestamp is younger than the timestamp. Similarly, the second computer system device replaces key-value pairs in the set of key-value pairs with key-value pairs in the second set of key-value pairs. Thus, the cluster control state transitions into a common state, a state forty 330. In the state forty 330, the memory device comprises “key 1” referencing a “value 1”, “key 4” referencing a “new value 4” and “key 5” referencing “value 5.

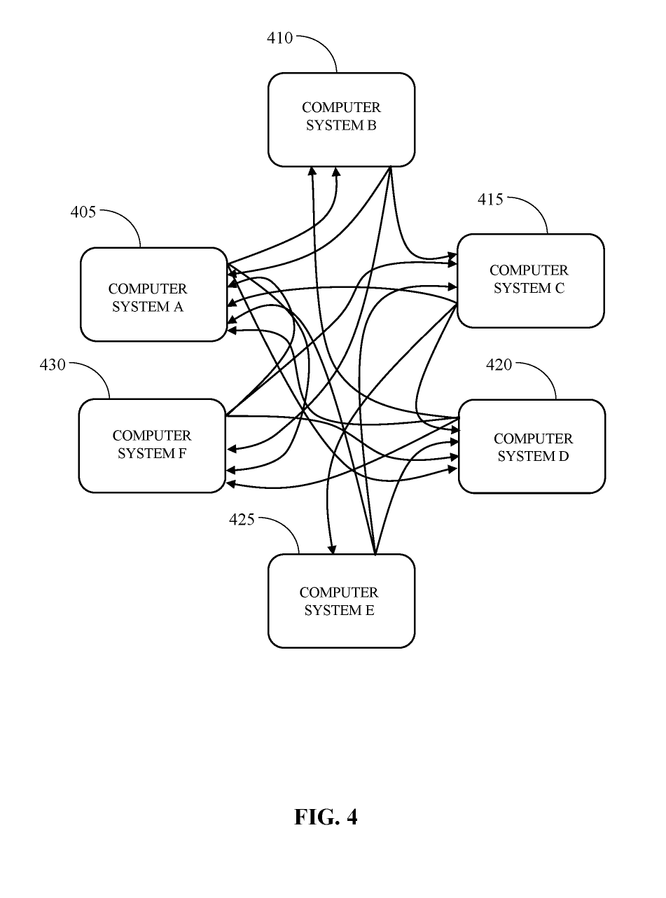

Referring now specifically to FIG. 4, such exemplarily illustrates a schematic diagram showing a cluster control peer-to-peer connection among a cluster of computer systems, according to an embodiment of the present invention. The cluster comprises a computer system A 405, a computer system B 410, a computer system C 415, a computer system D 420, a computer system E 425 and a computer system F 430.

The computer system A 405 is referred to as a primary computer system. For initiating the cluster, every computer system goes through an initialization process. During initialization, each computer system in the cluster checks in with the primary computer system, the computer system A 405. The computer system A 405 is thereby informed about other computer systems in the cluster, during the initialization process. Further, the computer system A 405, receive information regarding any new computer systems in the cluster.

In one exemplary illustration of the present invention, each computer system in the cluster transmits information periodically to at most three computer systems. Because of working of the present invention, any change made in any key-value pairs stored in the computer System B 410 or any other computer system gets replicated to the computer system A 405 and then throughout the cluster. The present invention also implements a check in period in which every computer system in the cluster connects with the computer system A 405 to update the computer system A 405 on any new system updates. If there are less than three computer systems in the cluster, the computer systems exchange information with the available computer systems. If there are more than three computer systems in the cluster, the computer systems exchange information with only three other computer systems. In case a computer system does not respond to a request within a predetermined period, the transmitting computer system sends data to the other two computer systems. An unresponsive computer system is not immediately removed from the cluster. Removal of a computer system requires removal of data associated with network statistics, for example, IP address of the computer system from the data sets stored in the other computer systems. The data set or the components of the data set with the timestamp identifier representing the latest time is stored as the latest version of the data set.

In an embodiment, all computer systems in the cluster start with knowledge of common addresses of other computer systems in the cluster and initially connect to the other computer systems. The primary computer system, will always attempt to synchronize state with the second computer system, the floating “virtual IP” of the storage cluster, and the dashboard Virtual Machine (VM). For all other computer systems, the connection attempt will always try the primary computer system, the floating “virtual IP” of the storage cluster, and the dashboard VM. In an embodiment, once per minute, each computer system participating in the cluster attempts to synchronize with three other known members of the cluster to reach a consistent state. The floating “virtual IP” of the storage cluster is always tried first (unless the computer system is the floating storage computer system), followed by the any number of random hosts until at least three are reached. Value keys are stored as “facts” in the cluster control repository. At any point, these “facts” may be removed, added, or changed by the system controller and the changes will eventually propagate throughout the cluster. When cluster control notices that a fact has changed in state in some way, depending on the fact, appropriate action will be taken only on the computer systems where the change is applicable.

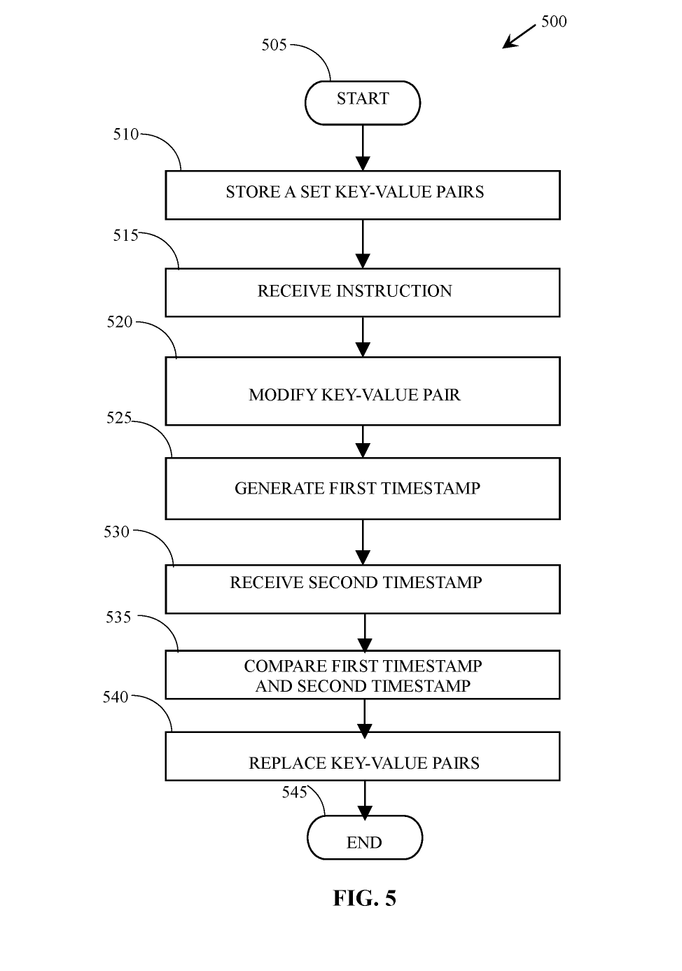

Referring now to FIG. 5, such is a flowchart of a computer implemented method 500 of patching software in a target computer system device in accordance with various embodiments of the invention. The method 500 is incorporated in an environment. the environment comprises a first computer system device, a second computer system device and a third computer system device. In one example, the first computer system device, the second computer system device, and the third computer system device are connected as a computer cluster. The first computer system device, the second computer system device, and the third computer system device are at least one of a laptop, a personal computer, a server, a smart phone, a network hardware device, and a smart television. The network hardware device is at least one of a gateway, a router, a network bridge, a modem, a wireless access point, and a network switch. In another example, the first computer system device, the second computer system device, and the third computer system device are gateways to at least one of a wide area network, a local area network, and internet. The first computer system device, the second computer system device, and the third computer system device are connected via a network. The network is at least one of a mobile network, a wide area network, a local area network, and internet. The first computer system device comprises a first memory device and a first processor. The second computer system device comprises a second memory device, and the second processor. The third computer system device comprises the third processor. In one embodiment of the present invention, the computer cluster comprising the first computer system device, the second computer system device, and the third computer system device hosts a system for patching software in a target computer system device. In one example, the target computer system device is at least one of the first computer system device, the second computer system device, and the third computer system device. At least one of the first memory device and the second memory device stores a set of program modules. The method 500 commences at step 505.

At step 510, each of the first memory device and the second memory device stores a set of key-value pairs. The set of key-value pairs is associated with a timestamp. The timestamp references to time of modification of the set of key-value pairs. In one example, the first memory device stores a first set of key-value pairs, and the second memory device stores a second set of key-value pairs. The set of program modules comprises an input module, a comparator module, and a propagation module. At least one processor among the first processor, the second processor, and the third processor executes the set of program modules. The at least one processor executes the set of program modules to propagate modifications in key-value pairs across the cluster. In one example, the set of program modules are executed by a combination of multiple processors among the first processor, the second processor, and the third processor. In another example, the memory device stores the set of program modules. and the set of key-value pairs. The set of key-value pairs is associated with a timestamp. The set of key-value pairs store at least one of license keys, authorization keys, encryption keys, authentication information, system configuration information, system configuration settings, network information, hot patch scripts, boot file scripts, user information, multimedia files, documents, system files, and image files. The memory device enables retrieval of the set of program modules and the set of key-value pairs into a processor. In one example, the processor executes the set of program modules.

In one example, the system for propagating modifications in key-value pairs across a cluster of computer system devices comprises a plurality of processors. Each processor among the plurality of processors, is comprised in the cluster of computer system devices. At least one processor executes the set of program modules. In one example, the processor executes the set of program modules. The set of program modules comprises an input module, a comparator module, and a propagation module.

At step 515, the input module, executed by the processor, receives a first instruction to modify a first set of key-value pairs stored in a first memory device in the cluster. In one example, the input module receives the first instruction from one of a user and a computer system device. In one example, the first set of key-value pairs is stored in the memory device. The first instruction instructs the processor to at least one of modify a first value set in the first set of key-value pairs, insert a first key-value pair into the first set of key-value pairs, delete at least one key-value pair from the first set of key-value pairs, and modify at least one key from the first set of key-value pairs.

At step 520, the input module modifies the first set of key-value pairs based on the first instruction.

At step 525, the input module generates a first timestamp referring to time of modification of the first set of key-value pairs.

At step 530, the input module is configured to receive a second timestamp associated with a second set of key-value pairs. The second set of key-value pairs are stored in a second memory device (not shown). The second timestamp represents time of latest modification of the second set of key-value pairs. Further, the input module transmits the second timestamp and the first timestamp into the comparator module.

At step 535 the comparator module, compares the first timestamp with the second timestamp. In one example, if time referenced by the first timestamp is later than time referenced by the second timestamp, then the comparator module compares each key-value pair in the first set of key-value pairs with each key-value pair in the second set of key-value pairs.

At step 540, the propagation module replaces a first key-value pair in the second set of key-value pairs with a second key-value pair in the first set of key-value pairs, based on the second key-value pair being non-identical with the first key-value pair. In another example, if time referenced by the first timestamp is later than time referenced by the second timestamp, then the propagation module, replaces key-value pairs in the second set of key-value pairs with key-value pairs in the first set of key-value pairs.

The method 500 ends at step 545.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for propagating modifications in key-value pairs across a cluster of computer system devices, the system comprising:
a cluster of computer system devices;
one or more memory devices, comprised in one or more computer system devices of the cluster of computer system devices, wherein each memory device among the one or more memory devices stores:
a set of program modules, and
a set of key-value pairs, wherein the set of key-value pairs is associated with a timestamp;
a plurality of processors, a processor among the plurality of processor being comprised in a computer system device of the cluster of computer system devices, wherein at least one processor executes the set of program modules, the set of program modules comprising:
an input module, executed by the at least one processor, configured to:
receive a first instruction to modify, a first set of key-value pairs, the first set of key-value pairs being stored in a first memory device among the one or more memory devices,
modify the first set of key-value pairs based on the first instruction,
generate a first timestamp for the first set of key-value pairs, and
receive a second timestamp associated with a second set of key-value pairs, the second set of key-value pairs being stored in a second memory device among the one or more memory devices,
wherein the first timestamp references time of modification of the first set of key-value pairs;
a comparator module, executed by the processor, configured to compare the first timestamp with the second timestamp; and
a propagation module, executed by the processor, configured to replace key-value pairs in the second set of key-value pairs with key-value pairs in the first set of key-value pairs, based on time referenced by the first timestamp being later than time referenced by the second timestamp.

2. The system of claim 1, wherein the first instruction instructs the at least one processor to at least one of:
modify a first value set in the first set of key-value pairs,
insert a first key-value pair into the first set of key-value pairs,
delete at least one key-value pair from the first set of key-value pairs, and
modify at least one key from the first set of key-value pairs.

3. The system of claim 1, wherein the input module receives the first instruction from at least one of a user and at least one computer system device in the cluster.

4. The system of claim 1, wherein values in the set of key-value pairs are at least one of license keys, authorization keys, encryption keys, authentication information, network information, hot patch scripts, boot file scripts, user information, multimedia files, documents, system files, and image files.

5. The system of claim 1, wherein the comparator module is further configured to compare each key-value pair in the first set of key-value pairs with each key-value pair in the second set of key-value pairs, based on time referenced by the first timestamp being later than time referenced by the second timestamp.

6. The system of claim 1, wherein each computer system device in the cluster of computer system device is at least one of a laptop, a server, a network hardware device, a personal computer, and a smart phone, or any combination thereof.

7. The system of claim 1, wherein the timestamp references time of modification of the set of key-value pairs.

8. The system of claim 6, wherein the network hardware device is at least one of a gateway, a router, a network bridge, a modem, a wireless access point, and a network switch.

9. The system of claim 1, wherein the first memory device is stored in a first computer system device in the cluster and the second memory device is comprised in a second computer system device in the cluster.

10. A method of propagating modifications in key-value pairs across a cluster of computer system devices, the method comprising:
storing in each memory device of one or more memory devices, a set of key-value pairs, wherein the set of key-value pairs is associated with a timestamp;
receiving at least one processor via an input module, a first instruction to modify, a first set of key-value pairs, the first set of key-value pairs being stored in a first memory device among the one or more memory devices;
modifying by the at least one processor via the input module, the first set of key-value pairs based on the first instruction;
generating by the at least one processor via the input module, a first timestamp for the first set of key-value pairs, wherein the first timestamp references time of modification of the first set of key-value pairs;
receiving by the at least one processor via the input module, a second timestamp associated with a second set of key-value pairs, the second set of key-value pairs being stored in a second memory device among the one or more memory devices;
comparing by the at least one processor via the comparator module, the first timestamp with the second timestamp; and
replacing by the at least one processor via a propagation module, key-value pairs in the second set of key-value pairs with key-value pairs in the first set of key-value pairs, based on time referenced by the first timestamp being later than time referenced by the second timestamp, thereby synchronizing the first memory device with the second memory device.

11. The method of claim 10, wherein the first instruction instructs the at least one processor to at least one of:
modify a first value set in the first set of key-value pairs,
insert a first key-value pair into the first set of key-value pairs,
delete at least one key-value pair from the first set of key-value pairs, and
modify at least one key from the first set of key-value pairs.

12. The method of claim 10, wherein the input module receives the first instruction from at least one of a user and at least one computer system device in a cluster of computer system devices.

13. The method of claim 10, wherein values in the set of key-value pairs are at least one of license keys, authorization keys, encryption keys, authentication information, network information, hot patch scripts, boot file scripts, user information, multimedia files, documents, system files, and image files.

14. The method of claim 10, wherein the comparator module is further configured to compare each key-value pair in the first set of key-value pairs with each key-value pair in the second set of key-value pairs, based on time referenced by the first timestamp being later than time referenced by the second timestamp.

15. The method of claim 10, wherein each computer system device in the cluster of computer system device is at least one of a laptop, a server, a network hardware device, a personal computer, and a smart phone, or any combination thereof.

16. The method of claim 10, wherein the timestamp references time of modification of the set of key-value pairs.

17. The method of claim 15, wherein the network hardware device is at least one of a gateway, a router, a network bridge, a modem, a wireless access point, and a network switch.

18. The method of claim 10, wherein the first memory device is stored in a first computer system device in the cluster and the second memory device is comprised in a second computer system device in the cluster.
